(19) United States
(12) Patent Application Publication
(10) Pub. No.: US 2015/0026902 A1
(43) Pub. Date: Jan. 29, 2015

(54) SKIN CLEANING ROLLER

(71) Applicant: INCO INNOVATION, Järfälla (SE)

(72) Inventor: Jan Berglund, Jarfalla (SE)

(21) Appl. No.: 14/381,634

(22) PCT Filed: Sep. 8, 2013
(86) PCT No.: PCT/SE2013/051040

§ 371 Date: Aug. 28, 2014

(30) Foreign Application Priority Data
Oct. 4, 2012 (SE) 1230106-5

(51) Int. Cl. A47K 7/02; A61H 15/00

(52) U.S. Cl. CPC A47K 7/028; A61H 15/00
USPC 15/104.001

(57) ABSTRACT

A roller for cleaning the skin comprising a wheel mounted on a handle having means for mounting said wheel, and where the wheel's periphery has asymmetrical suction cups with elongated shapes. Said suction cups have their suction surfaces oriented out from the center axis of the wheel and are preferably made of rubber or elastomer.

This invention refers to a device used for cleaning the skin. Its primary function is to empty the pores from impurities such as acne, whelks, pimples and carbuncles. This function is achieved with the help of a wheel covered with suction cups. For the facial skin the roller can be seen as a development of existing face masks but it is significantly more efficient, and also has additional functions. The best result is achieved when combining the treatment with soap or cleaning creme that can dissolve hardened grease and tallow in the entrance of a pore. It can also preferably be used in combination with hot water in the bath and shower, or in the heat of a sauna for opening up the pores. The description will focus on the cleaning of the facial skin but is of course applicable to the whole body.

The pores of the skin can become occluded with impurities as a combination of tallow being released from sebaceous gland from the bottom of the pore and impurities with bacteria entering the pore from outside. Then when the utmost layer of tallow is dried out, it acts like a lid that encapsulates the bacteria in the pore. This can result in an inflammation such as acne or pimples.

The invention combines a gentle pressure with a distinct sucking function. These two functions can easily be repeated many times for one particular pore. Repeating these two functions with a soap or creme that dissolves tallow will remove the tallow lid that has dried out closest to the skin. So the repetition is important in order to do a deep cleaning of the skin and is done by simply rolling the wheel back and forth a number of times for the same area. Apart from the cleansing effect the roller is also massaging and therefore vitalizing for the skin. Even some skin disorders such as burstings and cellulites will profit from these advantages.

The invention comprises a handle which have one or more wheels mounted to it. The wheels has there periphery covered with small suction cups, probably made of silicone or elastomer. The suction cups have its hollow suction surfaces pointing outward from the wheels center axis. The rubber shall be soft, probably 30-50 ShoreA in hardness.

When the wheels are rolling against the skin, the first phase is that the suction cups circumference is pressed towards the skin. Then when the circumference is further compressed against the skin it stretches the skin a little at the same time as a small pressure is built up under the suction cup. This pressure will continue until the air pocket under the suction cup is emptied. The air pocket is of course, preferably partly filled with water, cleansing crème or soap. During the time that the air pocket with cleaning agent is being emptied some of the cleaning agent will be pressed into the pore which has become more open due to the initial stretching. When all of the air pocket is emptied the process reverses since the suction cup has passed the center of the wheel, and gets a grip on the skin as it rises from the surface. Thanks to the hollow suction surface a negative pressure is created under the suction cup. Now the skin is stretched even more under the suction cup due to the fact that the skin is lifted at the most in the center. The combination negative pressure, lifting and stretching of the skin has the effect of emptying some of the contents of the pores right under the center of the suction cup. Repeating this a few times over a number of pores is done very easy and quick and the result is a deep cleaning effect of those pores.

The suction cups are small so that every time they passes over a pore they exchanges parts of the pores content. The negative pressure while sucking is bigger than the positive pressure while pressing and that leads to the pore containing less and less impurities during treatment. By rolling the wheel back and forth it is very easy to deep clean big areas of the skin and remove slag products in the form of blackheads, carbuncles, tallow, bacteria and sweat, that has accumulated in the pores. In order to enhance the cleaning effect one can replace the cleaning agent during the treatment and thereby replacing contaminated crème or soap. It can also be done under the water surface or in the shower in order to rinse the pores with only water, this is a good way to empty the pores from the last remains of crème or soap at the end of a treatment session.

In order to be effective on different parts of the body it is convenient to have two different wheel types on the same handle. One broad wheel for cleaning flat surfaces such as cheeks, forehead and shoulders. One narrow wheel, maybe vaulted and with tilted (a°) suction cups (see FIG. 1a) in order to reach areas that are uneven, like around the nose or in collops. Then, by angling the handle sideways when rolling, it is possible to reach these areas as well. It might also be suitable to manufacture a few variants, like different sizes or shapes of the suction cups to adapt to different skin types. Different diameters of the wheels might also be an advantage, the diameter will probably be in the range ø10-ø20 mm.

Since the suction cups are placed on a cylindrical surface the cups will approach and move out from the skin leaning in various angles. To make it easier for each cups possibility to get a good grip and hold it for a while it is better if they are less extended in the rolling direction. An all circular suction cup have to be quite small in order to not be folded when rolling in towards the surface of the skin. One fold can endanger the sealing and hence no negative pressure can be created. For that reason it is better for each suction cup to have shorter extension in the rotational direction, and be elongated in the direction that is perpendicular with the rolling direction of the suction cups. The elongation increases the size of the hollow suction surface without increasing the risk for folding.

It is also an advantage if the suction cups are asymmetrically shaped in the way that they are extended more towards one rolling direction and less towards the other. Then when the wheel is rolling in one direction, as in FIG. 4b, it is mainly the weaker positive pressure that will be created. This is due to the fact that the side of the asymmetrical cup that first lifts from the skin is short and inflexible and lifts(b) easily from the skin without creating a negative pressure. In the opposite direction, FIG. 4c, an extra strong negative pressure will be created since the cup will hold on to the skin extra long time. The reason for that is that the first part that will start to move out from the skin is extended and therefore more flexible and adaptable (illustrated in FIG. 4c with dotted lines) and will hold on to the skin up to a bigger rotational angle.

In this way the rolling back and forth makes it active with suction only in one direction. One example of a situation when this is beneficial is when rolling vertically on the cheek up and down, probably the most common way to use the device. If the suction is active while rolling upwards on the skin it will be very easy to change direction downwards close to the soft skin right underneath the eye since the suction will be deactivated then. The suction from the suction cups would be too tough on areas such as under the eyes or close to the mouth, at least in some directions.

Because of the pore rinsing effect of the invention it might also be used as a treatment against insect bites or contact allergy in that it will suck out the poison. Then instead of a cleansing creme, maybe some medical salve is more useful.

The fact that the positive pressure pushes in small amounts of the fluid that is placed on the skin makes it suitable for massaging in salves and liniment for a deeper treatment of muscles as well.

One could even use the device to massage in medical substances instead of using injections, like the use of plasters with painkiller or nicotine. In that case it would be recommended to mainly roll in the direction that makes the suction cups leave a positive pressure and no suction.

Hair might be a problem when building up the negative pressure but the use of a slightly thicker creme will help. It will give a good sealing even if a few hair straws has come between the suction cups circumference and the skin.

Acne, which is an inflammation in the sebaceous gland that are placed under the pores might be treated by rolling in anti inflammation salve at the same time as the cups opens up the pores so that tallow and bacteria gets an exit out of the pores.

### STATE OF THE ART

One of the benefits with the invention compared to many already existing skin care devices is its simplicity. There is no need for electricity, laser or running water and each and every one can easily use this product themselves. As easy as brushing your teeth you can now have a skin treatment. All this makes it easy to have continuity in the skin care. To visit a skin therapist can be quite expensive and you also have to make reservations.

There are a number of devices and products for cleaning the skin, ranging from face masks and peeling to advanced apparatus, often with a combination of water jets and massage. The presented invention might be best compared with the face mask because they both in some extent sucks or draws out impurities from the pores. A face mask is a crème that you apply to the skin, after a few minutes it solidifies into a rubberlike gel. Then when removing the mask some impurities are drawn out of the pores. The advantage of the invention is that one can easily repeat the same cleaning process over and over again for every pore but the face mask only processes each pore one time. Another advantage is as mentioned earlier the overpressure that massages in cleaning crème, pore opening crème or medicals in the pore over and over again. It is the repeating of the process that makes it very efficient. The facemask does not really build up any under pressure or over pressure as the suction cups does.

There are also a number of various “Skin rollers” on the market which are rollers for massaging and vitalizing the skin, often with small bumps or irregularities on the wheels. The more advanced machines for cleaning the skin are often depending on electricity, vacuum pumps, laser or running water and do often requires a professional user.

Another skin cleaning product is peeling. Peeling is a way of scrubbing the skin with a paste or crème containing grains or chemicals and is used to remove dead skin layers. Peeling has no actual rinsing effect on the pores but it can open them up by removing dead skin that is blocking the pore entrance. A classical way to open up the pores is by use of steam or the heat in a sauna. Many treatments against pimples and comedones are unfortunately built on the principle of squeezing them out. Squeezing might be unhealthy if it is not done in the right way. It is when a pimple gets trapped and squeezed down deeper in the skin it can get really harmful. Professional therapists also do this but in combination with cremes and heat.

There is a machine with a similar function as the invention in that it uses a negative pressure above the skin surface. The treatment is called LGP liftmassage and is said to be a cure against acne, cellulites and wrinkles. The under-pressure that is produced by a vacuum pump lifts the skin between two rolls. The two rolls is moving back and forth towards each other a number of times per second and that movement squeezes the skin at the same time as it is lifted by the negative pressure above. It lacks the skin stretching function of the suction cup, its more like it pushes it together. The method is expensive since it is an advanced machine with a lot of moving mechanics and pumps and must be operated by a professional skin therapist.

Yet another skin cleaning device on the market is called Aquapeeling and it consists of a pen like nozzle connected to a water hose giving a water jet that deep cleans the pores. Around the nozzle there is a plastic wall and a vacuum pump that removes the used water. There is a risk that bacteria are being flushed down to a deeper layer of the skin where the inflammations are more difficult to cure. A too strong water jet might stretch the skin around the pore too much. This machine is normally used by professional therapists and is not for home treatments. The present invention also has a pressure function to push in water, cleaning fluid or medicals in the pores but its pressure is by definition low since the construction of the suction cup is like that. The soft rubber that is needed to create the sucking function can not at the same time create a strong overpressure. And therefore there is no risk for pushing the bacteria deeper down in the pore.

### DESCRIPTION OF THE FIGURES

FIG. 1a Shows a narrow wheel (2) with leaning (a°) suction cups (9)

FIG. 1b Shows a complete roller (1) comprising a handle (5) with two different wheels (2) (3) in each end

FIG. 1c Shows a wide wheel (3) with multiple rows of elongated suction cups (10)

FIG. 2a Shows the wheel (3) mounted on devices (6) (7) for the purpose of being fastened or integrated by molding on the handle(5)

FIG. 2b Shows an exploded view of 2a

FIG. 3a Shows a wheel (3) of rubber or elastomer with suction cups (10) directed outwards from the wheels center axis

FIG. 3b Shows a longitudinal vertical section view of said wheel and the hollowed (12) suction surfaces (15)

FIG. 3c Shows a cross vertical section view of said wheel and the hollowed (13) suction surfaces (15)

FIG. 4a Shows a 3D view of a wheel (4) with elongated, asymmetrical suction cups (11)

FIG. 4b Shows a side view of a wheel (4) rotating counter clockwise, the asymmetrical joint (18) of the suction cup lifts (b) before any negative pressure worth mentioning is created

FIG. 4c Shows a side view of a wheel (4) rotating clockwise, the asymmetrical suction cup hold its grip to the skin longer due to the extended flexible part with an extra strong negative pressure as a result, indicated by dotted lines.

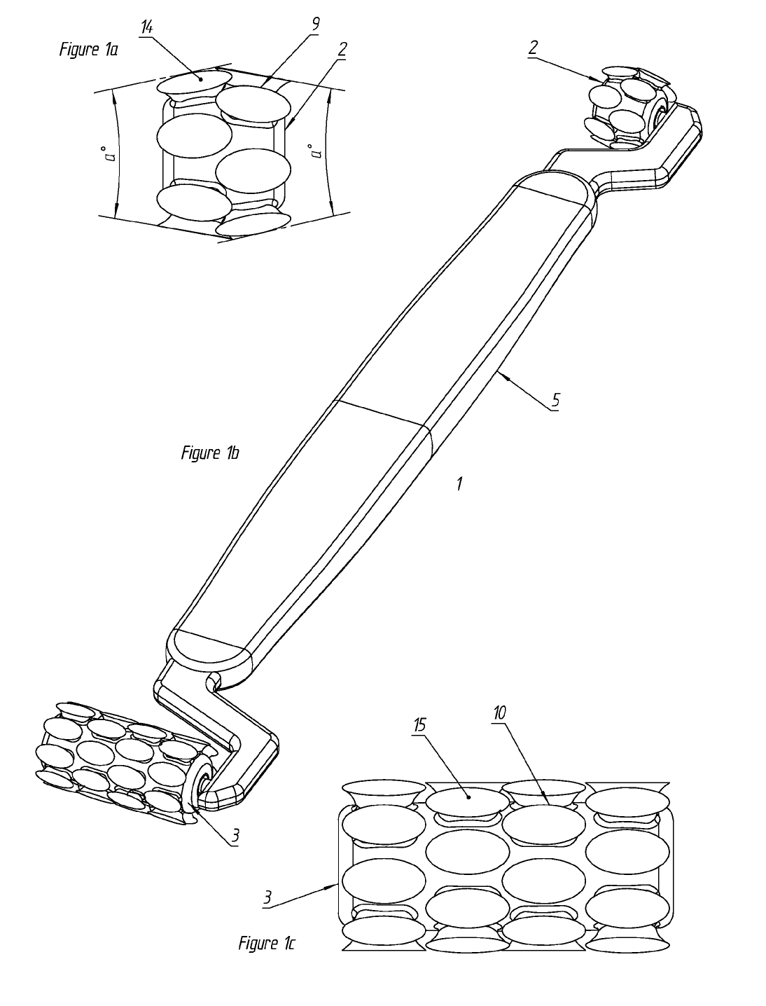

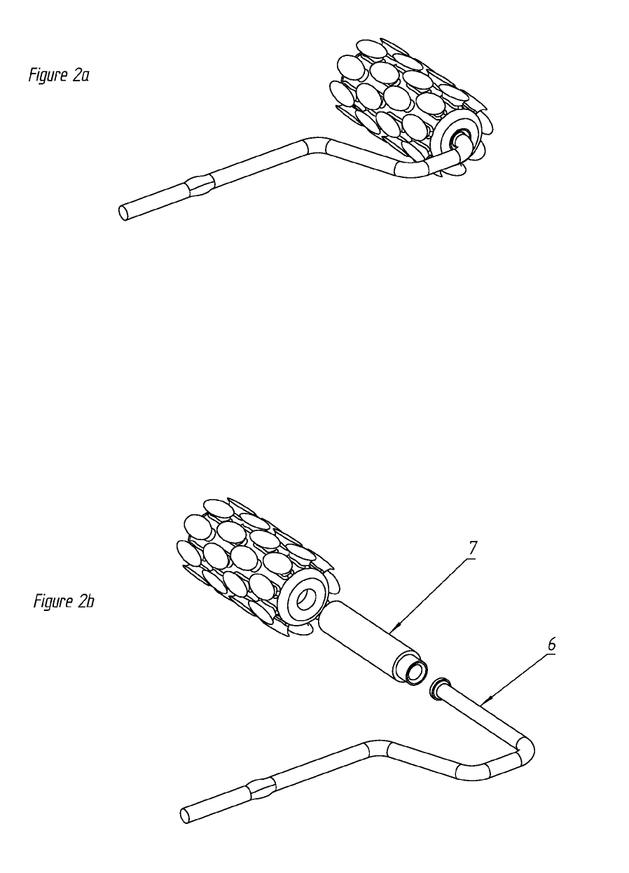

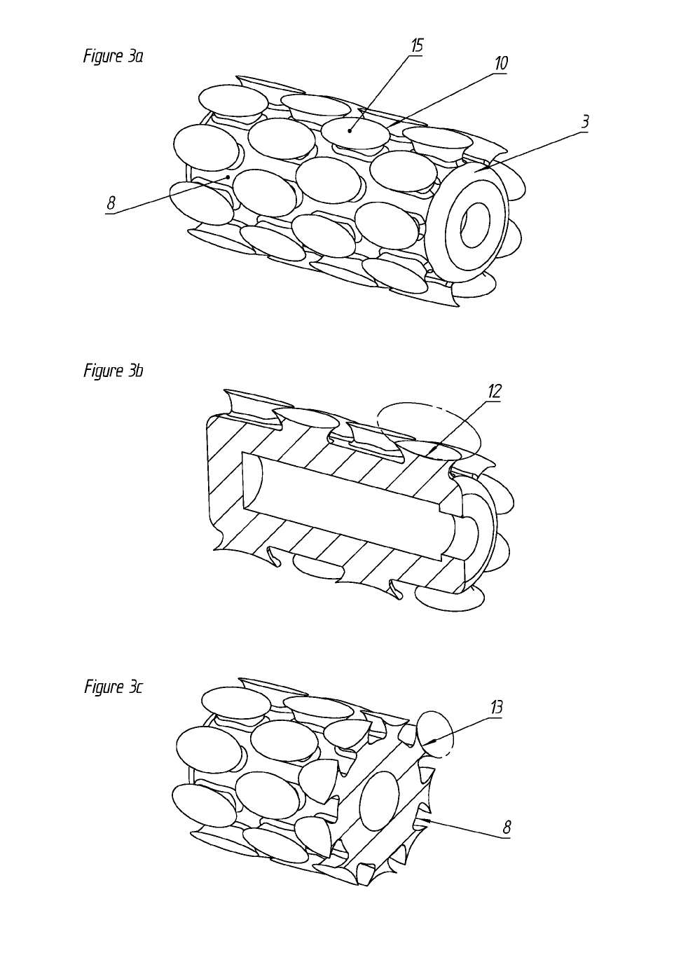

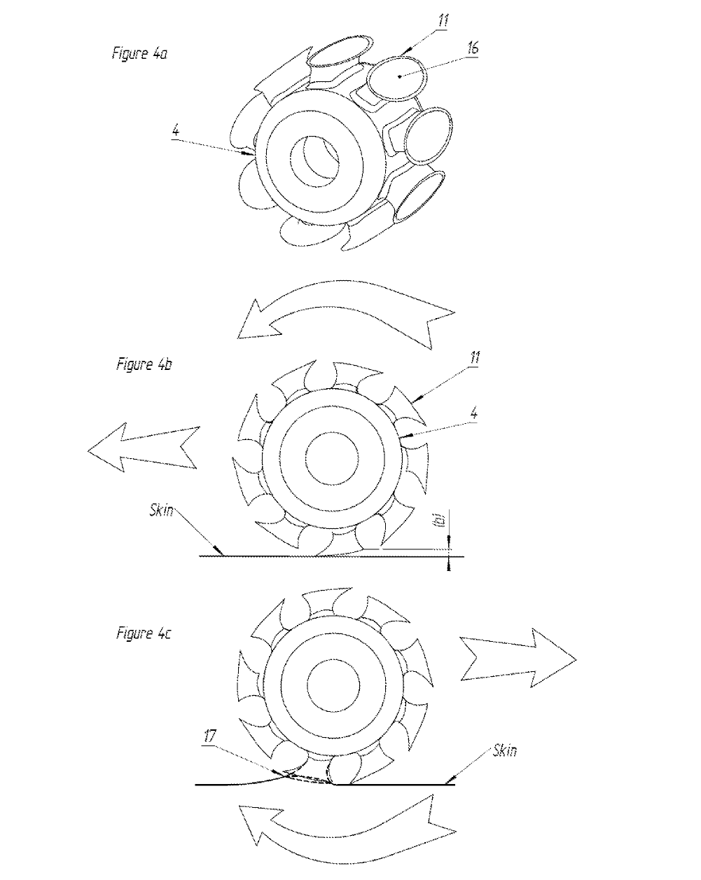

1. A roller intended for cleaning skin comprising a wheel mounted freewheeling on a handle with means for mounting said wheel on said handle, said roller is characterized by; that the wheels periphery have suction cups;
a, with their suction surfaces oriented out from the center axis of the wheel and;
b, with an elongated shape, for example elliptical or oval with the longitudinal axis essentially perpendicular to the rolling direction of the suction cups and;
c, that are asymmetrical.

2. A roller according to claim 1 wherein said suction cups have hollowed suction surfaces.

3. A roller as in claim 1 wherein said suction cups are made of rubber or elastomer.

4. A roller according to claim 1 with at least two wheels having their periphery covered with suction cups and with their suction surfaces pointing out from the center axis of the wheel.

5. A roller as in claim 4 wherein said wheels have different dimensions.

6. A roller as in claim 1 wherein said suction cups have different sizes and/or shapes on one wheel,

7. A roller as in claim 1 wherein said suction cups are leaning.

8. A wheel that has its periphery covered with suction cups, said suction cups have;
a, their suction surfaces oriented out from the center axis of the wheel and;
b, has an elongated shape, for example elliptical or oval with the longitudinal axis essentially perpendicular to the rolling direction of the suction cups and;
c, are asymmetrical.

9. A wheel as in claim 8 with suction cups having hollowed suction surfaces.

10. A wheel as in claim 8 wherein said suction cups are made of rubber or elastomer,

11. A roller for cleaning skin, comprising:
a first wheel rotatably coupled to a handle at a first end of the handle, the first wheel comprising a plurality of first suction cups each having a first surface configured so that the first surfaces are angled outward relative to a perpendicular axis of the first wheel; and
a second wheel rotatably coupled to the handle at a second end of the handle, the second end opposite the first end, the second wheel comprising a plurality of second suction cups configured so that the suction cups extend perpendicularly from the second wheel.

12. The roller of claim 11, wherein the first wheel has a first wheel width, wherein the second wheel has a second wheel width, and wherein the first wheel width is less than the second wheel width.

13. The roller of claim 11, wherein the first wheel comprises a oval shape.

14. The roller of claim 11, wherein the first wheel comprises an elliptical shape.

15. The roller of claim 11, wherein the first wheel is rotatably coupled to the handle using a device positioned inside the first wheel.

16. The roller of claim 11, wherein at least one of the plurality of first suction cups is configured to empty a skin impurity after being positioned upon skin having the skin impurity.

17. The roller of claim 11, wherein at least one of the plurality of first suction cups is asymmetrically shaped so that a first part of the at least one of the plurality of first suction cups extends in a first direction more than a second part of the at least one of the plurality of first suction cups.

18. The roller of claim 11, wherein at least one of the plurality of first suction cups is asymmetrically shaped so that rotation of the first wheel in a first direction along a user's skin causes a first negative pressure within the at least one of the plurality of first suction cups and rotation of the first when in a second direction opposite the first direction along the user's skin causes a second negative pressure within the at least one of the plurality of first suction cups, wherein the first negative pressure is different than the second negative pressure.

19. The roller of claim 11, configured to remove bacteria from a skin pore.

20. The roller of claim 11, wherein the first wheel has a diameter in the range of 10 mm to 20 mm.
